(19) United States
(12) Patent Application Publication
(10) Pub. No.: US 2013/0293599 A1
(43) Pub. Date: Nov. 7, 2013

(54) ELECTRONIC DEVICE AND CHROMATICITY ADJUSTMENT METHOD

(71) Applicants: Kenji Wakisaka, Takatsuki-shi (JP); Toshiaki Nade, Daito-shi (JP)

(72) Inventors: Kenji Wakisaka, Takatsuki-shi (JP); Toshiaki Nade, Daito-shi (JP)

(73) Assignee: KYOCERA CORPORATION, Kyoto (JP)

(21) Appl. No.: 13/980,668

(22) PCT Filed: Jan. 18, 2012
(86) PCT No.: PCT/JP2012/050946

§ 371 Date: Jul. 19, 2013

(30) Foreign Application Priority Data
Jan. 19, 2011 (JP) 2011-008788

(51) Int. Cl. G09G 5/02

(52) U.S. Cl. CPC G09G 5/02
USPC 345/690

(57) ABSTRACT

An electronic device includes a plurality of display modules, and an adjusting module operable to adjust chromaticity of the plurality of display modules. Each of the plurality of display modules comprises a display screen, and a backlight that emits light of a predetermined color and illuminates the display screen from the rear surface side. The display screens of the plurality of display modules are simultaneously viewable. The adjusting module performs, for each of plurality of display modules, an adjustment process for adjusting target chromaticity so that the target chromaticity to be displayed on the display module approaches a target value, the target chromaticity being chromaticity of the same color as the predetermined color.

### TECHNICAL FIELD

The present invention relates to a technique for adjusting chromaticity of a predetermined color displayed by an electronic device.

### BACKGROUND ART

Conventionally, various techniques of electronic devices have been proposed. For example, Patent Document 1 discloses a technique of mobile phones as one kind of electronic devices.

### PRIOR ART DOCUMENT

### Patent Document

Patent Document 1: Japanese Patent Application Laid-Open No. 2007-264124

### SUMMARY OF THE INVENTION

### Problems to be Solved by the Invention

As described in Patent Document 1, in electronic devices backlight-type display modules are occasionally used. In such display modules, variations among individuals in chromaticity of backlight cause variations among individuals in chromaticity of colors displayed by the display modules. In electronic devices having a plurality of backlight-type display modules for enabling display screens to be simultaneously viewed, variations in the chromaticity of the backlights on the respective display modules make a difference in chromaticity of the same color displayed on the plurality of display modules. Particularly, when the plurality of display modules displays the same color as that of the backlight, a variation in chromaticity among the plurality of display modules is noticeable. As a result, users who view the display screens on the plurality of display modules feel discomfort. When one image is displayed over the plurality of display modules, this discomfort is noticeable.

Therefore, the present invention was devised in view of the above circumstances, and an object thereof is to provide a technique capable of reducing a difference in chromaticity of the same color as that of backlight displayed by a plurality of display screens that is simultaneously viewable.

### Means for Solving the Problems

An electronic device according to an aspect includes a plurality of display modules, and an adjusting module operable to adjust chromaticity of the plurality of display modules, wherein each of the plurality of display modules comprises a display screen and a backlight operable to emit light of a predetermined color and to illuminate the display screen from the rear surface side, the display screens of the plurality of display modules are simultaneously viewable, and the adjusting module adjusts, for each of the plurality of display modules, target chromaticity so that the target chromaticity to be displayed on the display module approaches a target value, the target chromaticity being chromaticity of the same color as the predetermined color.

Further, a chromaticity adjustment method according to an aspect for an electronic device, the electronic device including a plurality of display modules each of which comprises a display screen and a backlight emitting light of a predetermined color for illuminating a rear side of the display screen, display screens of the plurality of display modules being simultaneously viewable, the method including the steps of: (a) measuring, for each of the plurality of display modules, target chromaticity to be displayed by the display module, the target chromaticity being chromaticity of the same color as the predetermined color, and (b) performing, for each of the plurality of display modules, an adjustment process for adjusting the target chromaticity based on a measured value of the display module obtained in the step (a) so that the target chromaticity of the display module approaches a target value.

### Effects of the Invention

According to the present invention, a difference in chromaticity of the same color as that of the backlight displayed by a plurality of display screens that is simultaneously viewable can be reduced.

Objects, features, aspects and advantages of the present invention will become more apparent from the following detailed description of the present invention when taken in conjunction with the accompanying drawings.

### BRIEF DESCRIPTION OF DRAWINGS

FIG. 1 is a perspective view illustrating an appearance of an electronic device.

FIG. 2 is a perspective view illustrating the appearance of the electronic device.

FIG. 3 is a perspective view illustrating the appearance of the electronic device.

FIG. 4 is a perspective view illustrating the appearance of the electronic device.

FIG. 5 is a block diagram illustrating an electrical configuration of the electronic device.

FIG. 6 is a diagram illustrating a configuration of a display module.

FIG. 7 is a diagram illustrating a variation range among individuals in chromaticity of white LED and the display module.

FIG. 8 is a flowchart illustrating a chromaticity adjustment method.

FIG. 9 is a flowchart illustrating the chromaticity adjustment method.

FIG. 10 is a flowchart illustrating the chromaticity adjustment method.

FIG. 11 is a flowchart illustrating the chromaticity adjustment method.

FIG. 12 is a diagram illustrating a state that the white chromaticity variation range is divided into a plurality of divided areas.

FIG. 13 is a diagram illustrating a state that the white chromaticity variation range is divided into the plurality of divided areas.

FIG. 14 is a diagram illustrating a state that the white chromaticity variation range is divided into a plurality of divided areas.

FIG. 15 is a diagram illustrating a target value and representative values set in the respective divided areas.

FIG. 16 is a diagram illustrating the target value and the representative values set in the respective divided areas.

FIG. 17 is a flowchart illustrating a method for generating adjustment information.

FIG. 18 is a diagram illustrating examples of numerical values with respect to respective values to be obtained at the time of generating the adjustment information.

FIG. 19 is a diagram illustrating a state that highest luminance of an R component is adjusted.

FIG. 20 is a diagram illustrating a state that highest luminance of a G component is adjusted.

FIG. 21 is a diagram illustrating a state that highest luminance of a B component is adjusted.

FIG. 22 is a diagram illustrating an adjustment amount of the highest luminance of each color component in the example of FIG. 15.

FIG. 23 is a diagram illustrating an adjustment amount of the highest luminance of each color component in the example of FIG. 16.

### EMBODIMENT FOR CARRYING OUT THE INVENTION

The present invention relates to a technique for adjusting chromaticity of a predetermined color displayed by an electronic device. An electronic device that is subject to chromaticity adjustment is first described.

<Appearance of the Electronic Device>

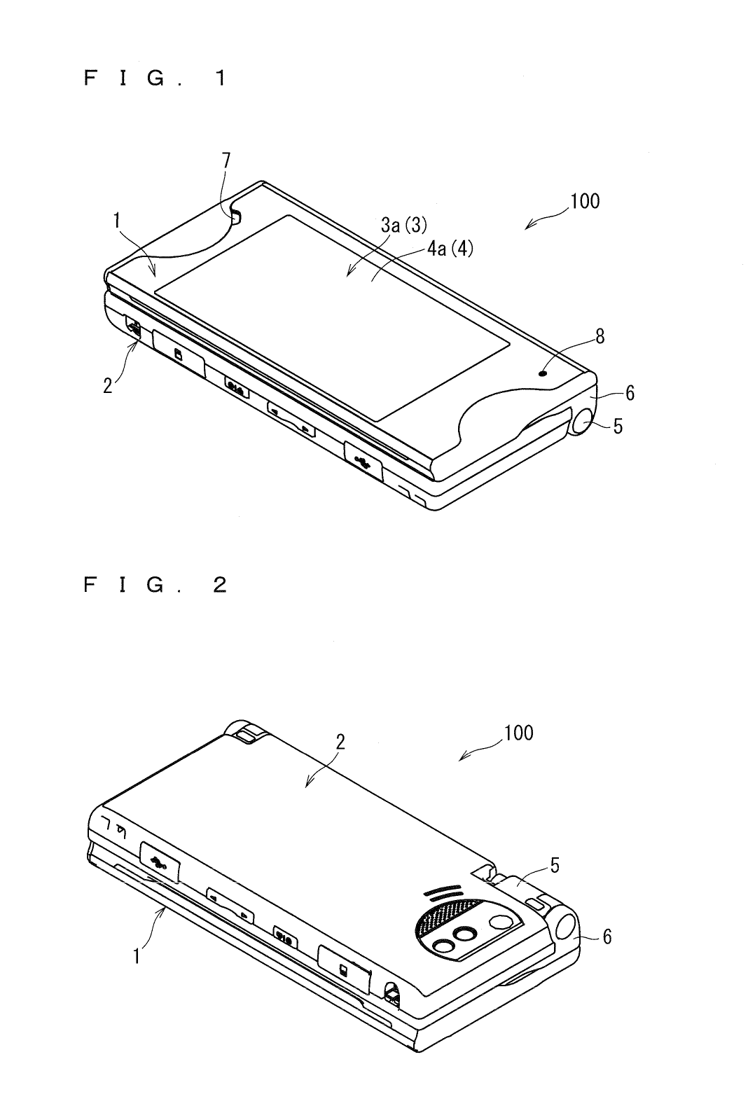

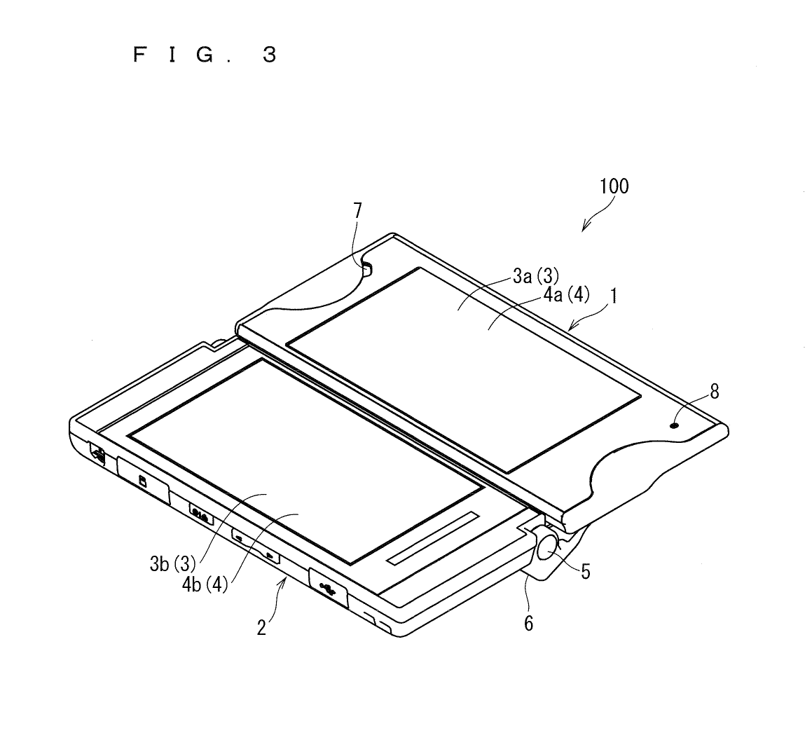

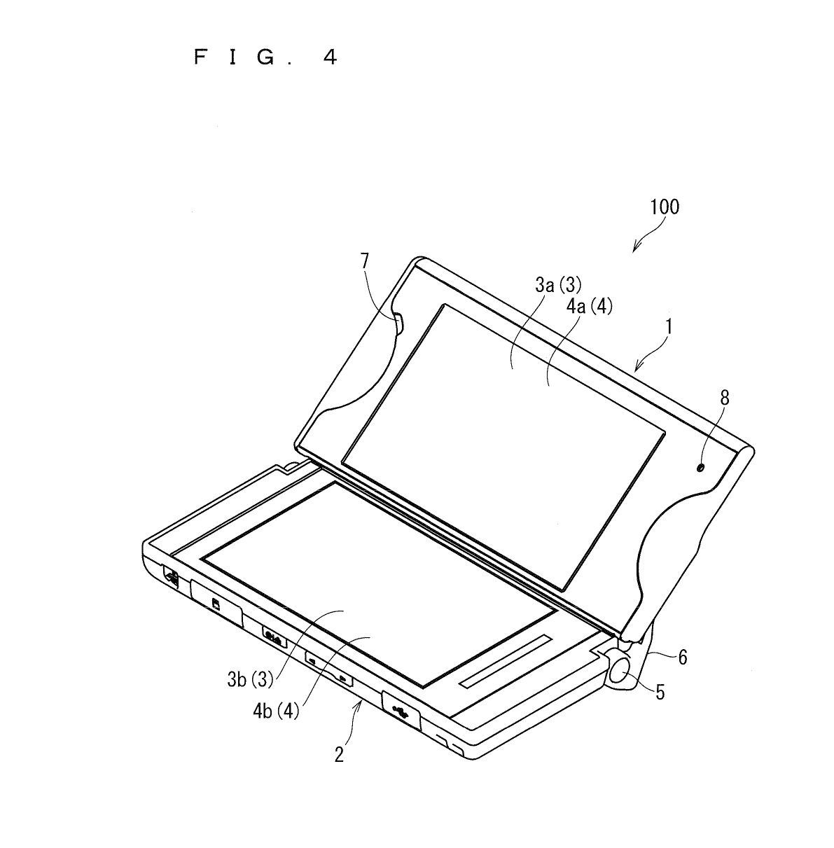

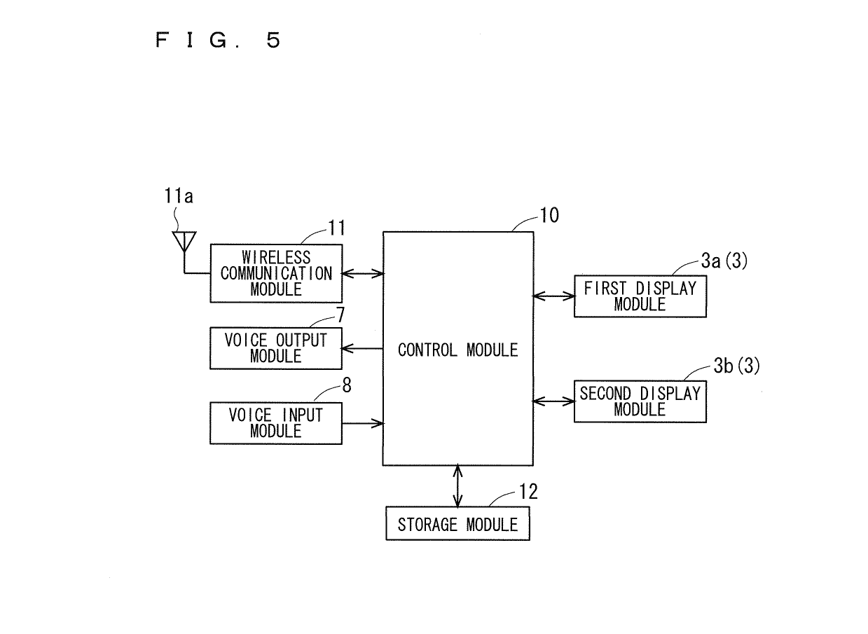

FIGS. 1 to 4 are perspective views each illustrating an appearance of an electronic device 100 according to an embodiment. The electronic device 100 is, for example, a mobile phone that can be opened and closed, and includes a first casing 1 and a second casing 2. FIG. 1 is a diagram of a case where the electronic device 100 in the closed state is viewed from the first casing 1 side, and FIG. 2 is a diagram of a case where the electronic device 100 in the closed state is viewed from the second casing 2 side. FIGS. 3 and 4 illustrate the electronic device 100 in the opened state.

The closed state of the electronic device 100 is, as shown in FIGS. 1 and 2, a state that a first display screen 4a of a first display module 3a provided in the first casing 1 is exposed, and the first casing 1 and the second casing 2 are arranged so as to be overlapped with each other. In this case, since the first display screen 4a and a second display screen 4b of a second display module 3b that is provided in the second casing 2 are overlapped with each other with a space, an angle formed by them can be said to be 0°.

On the other hand, the opened state of the electronic device 100 is, as shown in FIGS. 3 and 4, a state that the first casing 1 and the second casing 2 are arranged without overlapping so that the first display screen 4a of the first display module 3a and the second display screen 4b of the second display module 3b are simultaneously viewable. The electronic device 100 shown in FIG. 3 is opened so that the first display screen 4a and the second display screen 4b form 180°, in other words, lie in the same plane, and electronic device 100 shown in FIG. 4 is opened so that the first display screen 4a and the second display screen 4b form an angle that is larger than 0° and smaller than 180°.

The first casing 1 and the second casing 2 are connected by a hinge module 5 and an arm module 6. The hinge module 5 is provided to the second casing 2. The arm module 6 is connected to the hinge module 5 so that an angle with respect to the second casing 2 is changeable. Further, the arm module 6 is connected to the first casing 1 so that an angle with respect to the first casing 1 is changeable. The electronic device 100, the states in FIGS. 1 and 2 can transit to a state in FIG. 4 and the state in FIG. 4 can transmit to a state in FIG. 3 due to functions of the hinge module 5 and the arm module 6. Further, in the electronic device 100, the state in FIG. 3 can transit to the state in FIG. 4, and the state in FIG. 4 can transit to the states in FIGS. 1 and 2 due to the functions of the hinge module 5 and the arm module 6.

The first casing 1 is provided with a voice output module 7 and a voice input module 8 besides the first display module 3a. The voice output module 7 has a speaker, and the voice input module 8 has a microphone.

<Electrical Configuration>

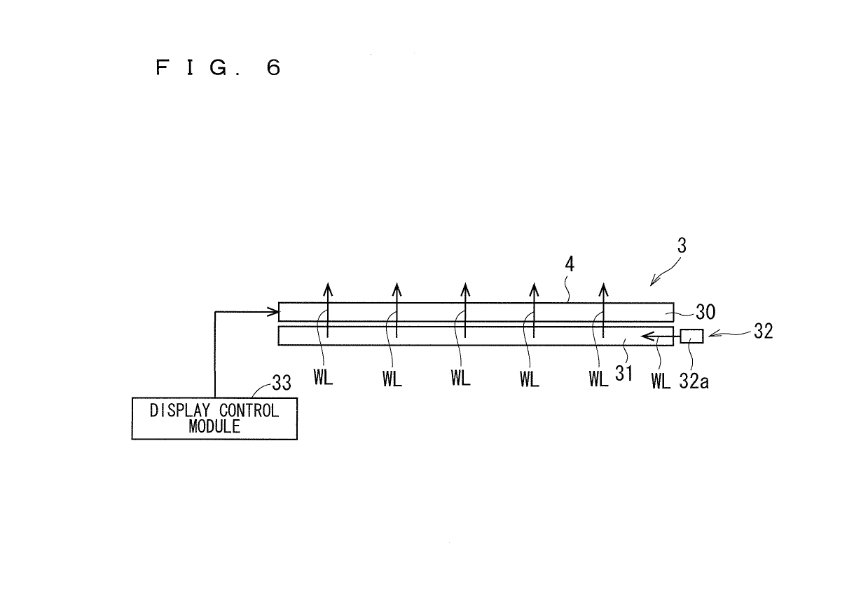

FIG. 5 is a block diagram illustrating an electrical configuration of the electronic device 100. As shown in FIG. 5, the electronic device 100 has a control module 10, a wireless communication module 11, and a storage module 12 besides the first display module 3a, the second display module 3b, the voice output module 7, and the voice input module 8.

The control module 10 includes a CPU (Central Processing Unit) and a DSP (Digital Signal Processor), and controls the other components of the electronic device 100 so as to generally manage an operation of the electronic device 100. The storage module 12 includes a ROM (Read Only Memory) and RAM (Random Access Memory). Respective functions of the control module 10 are realized in a manner that the CPU and the DSP of the control module 10 execute various programs in the storage module 12.

The wireless communication module 11 receives, via an antenna 11a, signals from mobile phones different from the electronic device 100, and communication devices such as web servers connected to an internet. The wireless communication module 11 performs an amplifying process and down converting on reception signals and outputs the signals to the control module 10. The control module 10 performs a decoding process on the input reception signals so as to obtain various data such as voice data included in the reception signals. Further, the wireless communication module 11 performs up converting and an amplifying process on transmission signals including the voice data generated by the control module 10 so as to wirelessly transmit the processed transmission signals to mobile phones different form the electronic device 100 and communication devices connected to internet via the antenna 11a.

The voice output module 7 converts the voice data from the control module 10 into a voice and outputs it to the outside. The voice input module 8 converts voices input from the outside into voice data and outputs the voice data to the control module 10.

The first display module 3a and the second display module 3b have a similar configuration. Hereinafter, when the first display module 3a does not have to be discriminated from the second display module 3b, each of them is called “display module 3”. Further, when the first display screen 4a does not have to be discriminated from the second display screen 4b, each of them is called “display screen 4”.

Each of the display modules 3 is, for example, a liquid crystal display module of a backlight type for carrying out color display, and displays various information such as characters, symbols and graphics based on an image signal input from the control module 10. Further, each of the display modules 3 has a touch panel function, and outputs, to the control module 10, operation signal according to operation through user's finger on the display screen 4. The user operates the display screens 4 of the respective display modules 3 so as to be capable of inputting various information to the electronic device 100.

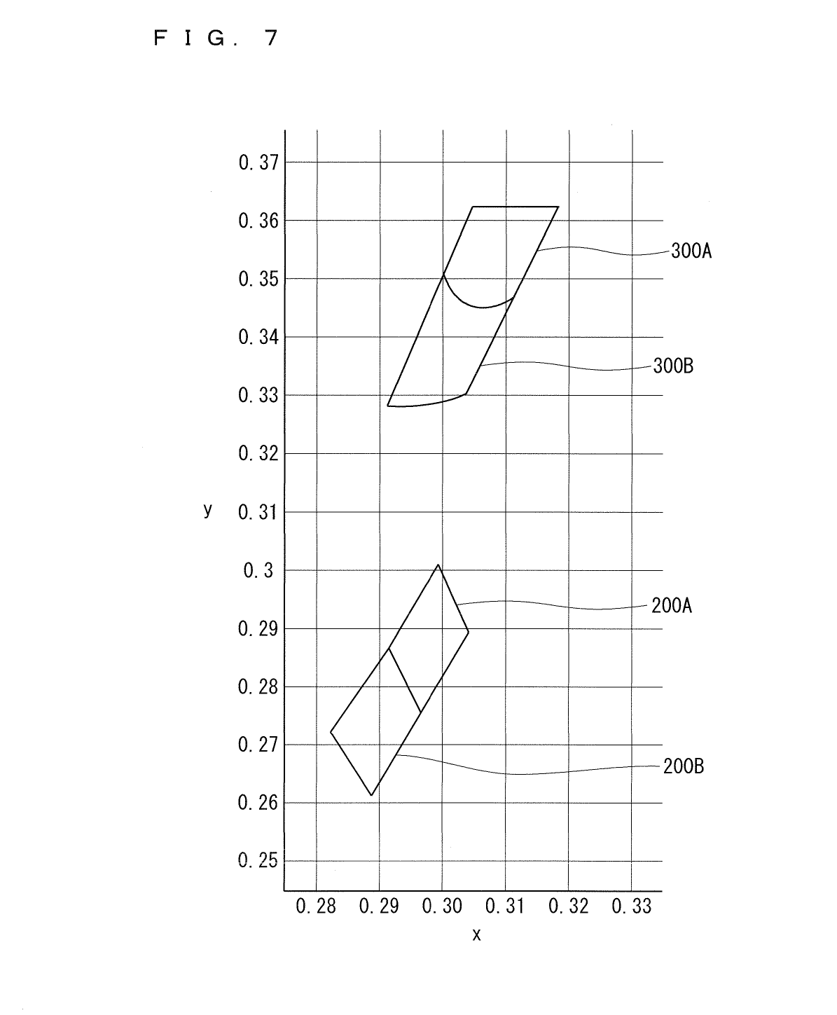

FIG. 6 is a diagram illustrating a configuration of the each of the display modules 3. As shown in FIG. 6, the display module 3 has a liquid crystal display panel 30, a light guide plate 31, a backlight 32 for emitting light of a predetermined color, and a display control module 33.

The backlight 32 is composed of, for example, a plurality of white LEDs (Light Emitting Diode) 32a. FIG. 6 illustrates only one of the plurality of white LEDs 32a. The light guide plate 31 is disposed on a rear surface side of the liquid crystal display panel 30, and guides white light WL emitted from the plurality of white LEDs 32a to the liquid crystal display panel 30. As a result, a display surface of the liquid crystal display panel 30, namely, the display screen 4 of the display module 3 is irradiated with the white light WL emitted by the backlight 32 from the rear surface side of the display screen 4.

The display control module 33 generates a drive signal based on an image signal input from the control module 10, and gives the drive signal to the liquid crystal display panel 30 so as to control display of the liquid crystal display panel 30.

<Chromaticity Adjustment Method>

A chromaticity adjustment method according to the embodiment for the electronic device 100 having the above configuration is described below.

As described above, in the electronic device 100, the display screen 4 of the display module 3 is illuminated by the backlight 32. Since the chromaticity of the white LEDs 32a composing the backlight 32 varies among individuals, chromaticity of the backlight 32 also varies among individuals. Further, when the display module 3 displays the same color (in this embodiment, white) as a color of emitted light from the backlight 32, chromaticity of the same color is greatly influenced by the chromaticity of the backlight 32. Therefore, when the chromaticity of the backlight 32 varies among individuals, chromaticity of the same color as the emitted light from the backlight 32 displayed by the display module 3 also varies among individuals.

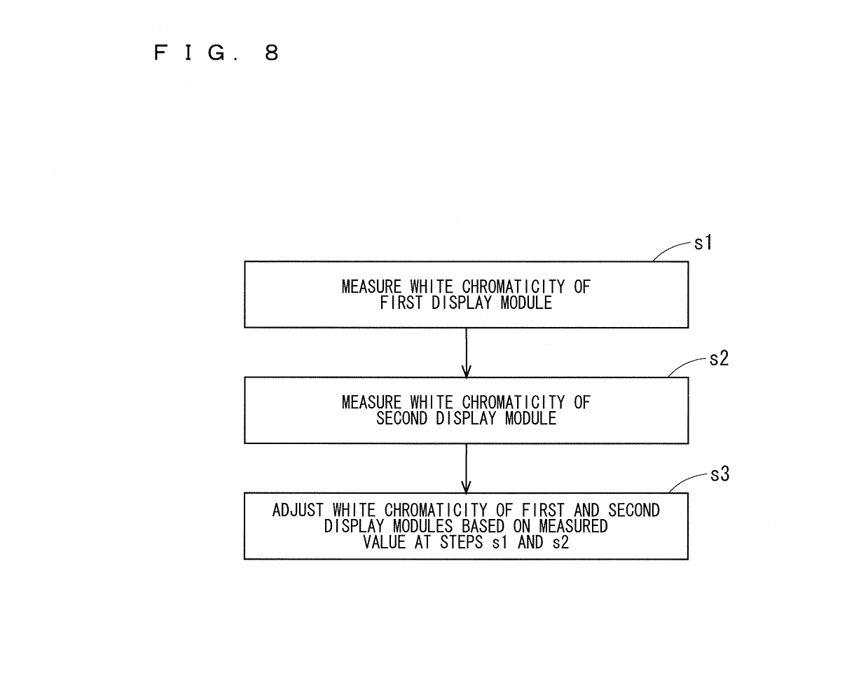

FIG. 7 is a diagram illustrating a variation range among individuals in the chromaticity of the white LEDs 32a, and a variation range among individuals in the chromaticity of the same color, namely white, as the color of the light emitted from the backlight 32 displayed by the display module 3. Hereinafter, the variation range of chromaticity among individuals is called “chromaticity variation range”. Further, the chromaticity variation range of white displayed by the display module 3 is particularly called “a white chromaticity variation range”. Further, the chromaticity of white displayed by the display module 3 is simply called “white chromaticity” in some cases. In FIG. 7, the chromaticity variation range is shown in a chromaticity diagram of CIE (Commission internationale de l'Eclairage).

In general, the chromaticity variation range of the white LED is defined by an index that is called “rank”. A chromaticity variation range of a certain rank is different from a chromaticity variation range of another rank. FIG. 7 illustrates a chromaticity variation range 200A of the white LED in a certain rank (temporarily called rank “A”) and a chromaticity variation range 200B of the white LED in another rank (temporarily called “rank B”). Further, FIG. 7 illustrates a white chromaticity variation range 300A of the display module 3 having the backlight 32 composed of the plurality of white LEDs 32a in the rank A, and a white chromaticity variation range 300B of the display module 3 having the backlight 32 composed of the plurality of white LEDs 32a in the rank B.

As shown in FIG. 7, when the chromaticity of the white LED 32a of the backlight 32 varies, the white chromaticity of the display module 3 also varies similarly. Note that, the chromaticity variation ranges 200A and 200B of the white LED shown in FIG. 7 are determined based on the rank defined by device manufacturer. Further, the white chromaticity variation ranges 300A and 300B of the display module 3 are determined by actually measuring the white chromaticity of the display module 3 while the white LEDs 32a mounted to the electronic device 100 are being changed.

The electronic device 100 according to the embodiment is, as shown in FIGS. 3 and 4 described above, the first display screen 4a of the first display module 3a and the second display screen 4b of the second display module 3b may be used in a state of being simultaneously viewable. In each of the first display module 3a and the second display module 3b, when the chromaticity of the same color as the color of the emitted light from the backlight 32 displayed by the display module 3 varies among individuals, in the same electronic device 100, the chromaticity of same color as that of emitted light from the backlight 32 displayed by the first display module 3a is different from chromaticity of the same color as that of the emitted light from the backlight 32 displayed by the second display module 3b. In such a case, when a user uses the electronic device 100 while the first display screen 4a of the first display module 3a, the second display screen 4b of the second display module 3b, and 0 are being simultaneously viewed, the user feels discomfort in the screen display. Particularly the discomfort is noticeable when one image is displayed over the first display module 3a and the second display module 3b.

Therefore, this embodiment proposes the chromaticity adjustment method for adjusting, for each of the first display module 3a and the second display module 3b, the chromaticity of the same color as that of the backlight 32 displayed by the display module 3, and reducing a difference in both the chromaticities so as to reduce the discomfort felt by the user who simultaneously views the first display screen 4a and the second display screen 4b. The chromaticity adjustment method according to the embodiment is described in detail below.

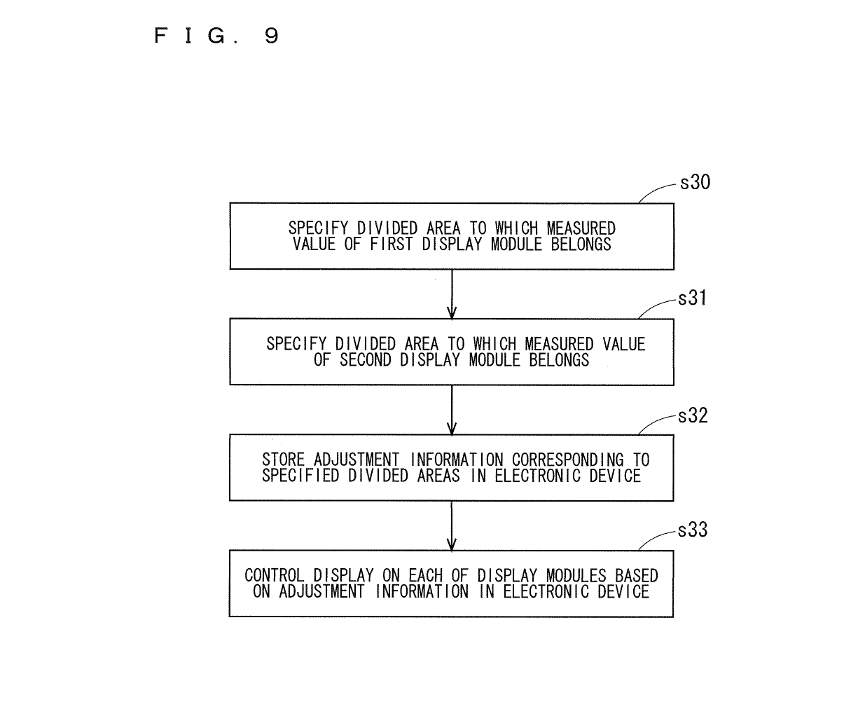

FIG. 8 is a flowchart illustrating the chromaticity adjustment method according to the embodiment. The chromaticity adjustment method according to the embodiment is carried out, for example, at process of manufacturing the electronic device 100.

In this embodiment, the electronic device 100 may be manufactured by using the white LEDs 32a of the rank A, or the electronic device 100 may be manufactured by using the white LEDs 32a of the rank B. Note that, one electronic device 100 always uses the white LEDs 32a of the same rank. Therefore, in one electronic device 100, the backlight 32 of the first display module 3a and the backlight 32 of the second display module 3b are composed of the white LEDs 32a of the same rank. When the backlights 32 of the first display module 3a and the second display module 3b are composed of the white LEDs 32a of the rank A, the white chromaticity variation range of the first display module 3a and the second display module 3b is “the white chromaticity variation range 300A” shown in FIG. 7. On the other hand, when the backlight 32 of the first display module 3a and the second display module 3b is composed of the white LEDs 32a of the rank B, the white chromaticity variation range of the first display module 3a and the second display module 3b is “chromaticity variation range 300B” shown in FIG. 7.

At the process of manufacturing the electronic device 100, when assembly of the first display module 3a and the second display module 3b is completed, as shown in FIG. 8, the white chromaticity of the first display module 3a is measured by a measuring instrument at step s1. At next step s2, the white chromaticity of the second display module 3b is measured by the measuring instrument.

When step s2 is carried out and the assembly of the electronic device 100 is completed, at step s3, the white chromaticity of the first display module 3a is adjusted based on the measured value obtained at step s1 so that the white chromaticity approaches a target value, and the white chromaticity of the second display module 3b is adjusted based on the measured value obtained at step s2 so that the white chromaticity approaches the target value. In such a manner, when the white chromaticity of the first display module 3a and the white chromaticity of the second display module 3b are made to approach the target value, a difference in both the white chromaticities can be reduced.

The process at step s3 is described in detail below. In this embodiment, the white chromaticity variation range of the display module 3 is divided into a plurality of divided areas, and adjustment information for making the white chromaticity of the display module 3 approach the target value by adjusting the white chromaticity is individually prepared for the respective divided areas correspondingly. Then, in the electronic device 100, the display on the display module 3 is controlled based on the adjustment information corresponding to the divided area to which the measured value of the white chromaticity of the display module 3 belongs, in the plurality of divided areas. Details of the divided areas and the adjustment information are described later.

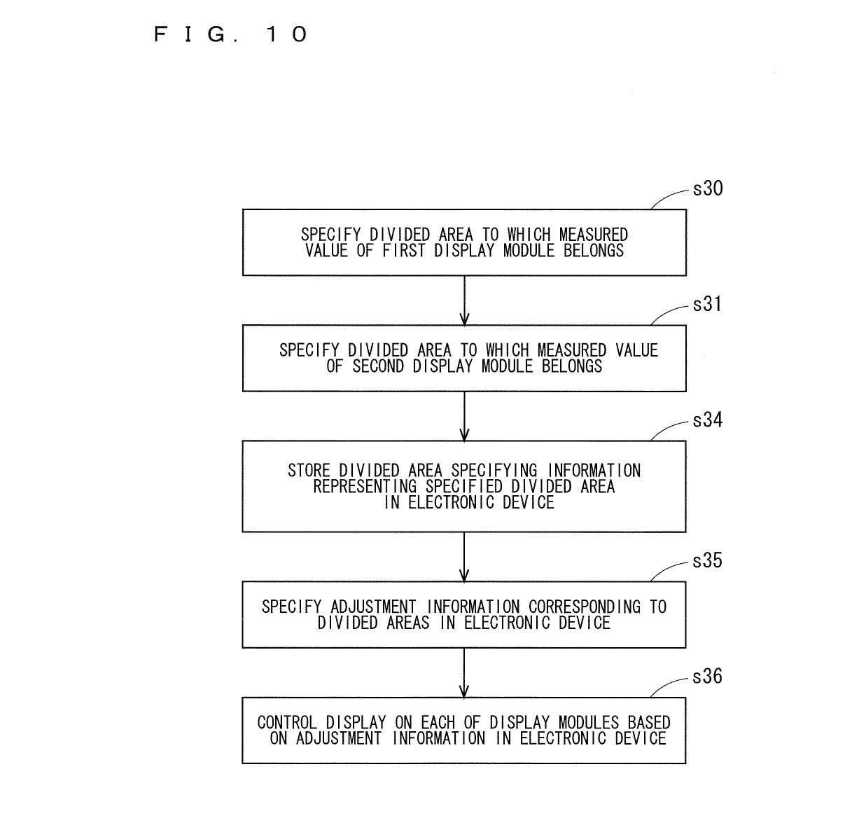

The embodiment proposes three examples of the process at step s3. FIGS. 9 to 11 are flowcharts illustrating the three examples. The process example in FIG. 9 is first described.

As shown in FIG. 9, at step s30, a divided area to which the measured value of the first display module 3a obtained at step s1 belongs is specified. At next step s31, the divided area to which the measured value of the second display module 3b obtained at step s2 belongs is specified. At steps s30 and s31, a worker may specify the divided areas to which the measured values belong, or a computer into which the measured values are input may specify the divided areas to which the measured values belong.

When step s31 is executed, at step s32, the adjustment information corresponding to the divided area specified at step s30 and the adjustment information corresponding to the divided area specified at step s31 are stored in the storage module 12 of the electronic device 100 by a computer connected to the electronic device 100.

The method for storing the adjustment information in the storage module 12 is not limited to this. For example, when a user may operate the display screen 4 of the display module 3 having the touch panel function and input adjustment information into the electronic device 100 so as to store the adjustment information in the storage module 12. Further, when the electronic device 100 has a hardware key, the user may operate the hard ware key and input adjustment information into the electronic device 100 so as to store the adjustment information in the storage module 12.

Thereafter, when the electronic device 100 is powered on in order to check the operation, at step s33, the display on each of the display modules 3 in the electronic device 100 is controlled based on the adjustment information corresponding to the display module 3 stored in the storage module 12. Concretely, in each of the display modules 3, the display control module 33 reads corresponding adjustment information from the storage module 12 via the control module 10, and controls the display on the liquid crystal display panel 30 based on the adjustment information. As a result, white having chromaticity close to the target value is displayed on each of the display modules 3. Thereafter, the electronic device 100 whose operation is checked is shipped. In the shipped electronic device 100, the display on each of the display modules 3 is controlled based on the adjustment information corresponding to the display module 3.

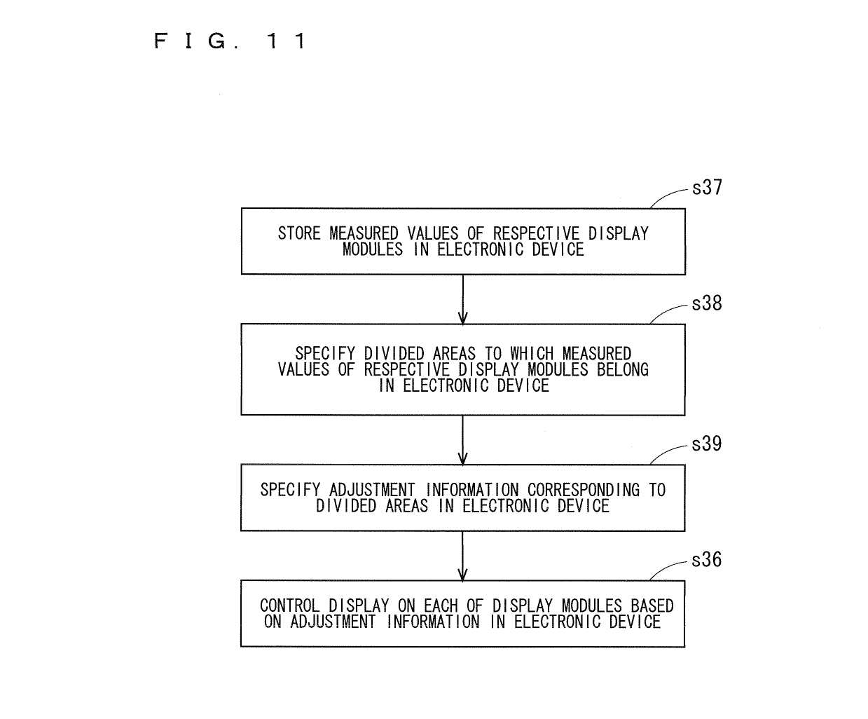

The process example in FIG. 10 is described below. When the process example in FIG. 10 is adopted, at a time point of the assembly of the electronic device 100, plural pieces of adjustment information corresponding to respective the plurality of divided areas, and correspondence relationship information representing the correspondence relationship between the plural pieces of adjustment information and the plurality of divided areas are stored in the storage module 12 of the electronic device 100.

As shown in FIG. 10, steps s30 and s31 described above are executed, and the divided area to which the measured value of the first display module 3a obtained at step s1 belongs and the divided area to which the measured value of the second display module 3b obtained at step s2 belongs are specified. At step s34, first divided area specifying information representing the divided area specified at step s30 and second divided area specifying information representing the divided area specified at step s31 are stored in the storage module 12 of the electronic device 100 by the computer connected to the electronic device 100.

Note that, the method for storing the first and second divided area specifying information in the storage module 12 is also not limited to this. For example, when the user operates the display screen 4, the first and second divided area specifying information may be stored in the storage module 12. Further, when the electronic device 100 has the hardware key, the first and second divided area specifying information may be stored in the storage module 12 by a user's operation of the hardware key.

Thereafter, when the electronic device 100 is powered on in order to check the operation, at step s35, the control module 10 reads the first divided area specifying information from the storage module 12. The control module 10 sees the correspondence relationship information in the storage module 12, and specifies adjustment information corresponding to a divided area representing the read first divided area specifying information, and reads the adjustment information from the storage module 12 so as to input it into the first display module 3a. Further, the control module 10 reads the second divided area specifying information from the storage module 12. The control module 10 sees the correspondence relationship information in the storage module 12, and specifies adjustment information corresponding to a divided area representing the read second divided area specifying information, and reads the adjustment information from the storage module 12 so as to input it into the second display module 3b.

At next step s36, in each of the display modules 3 of the electronic device 100, the display control module 33 controls the display on the liquid crystal display panel 30 based on the input adjustment information. As a result, white having chromaticity close to the target value is displayed on each of the display modules 3. Thereafter, the electronic device 100 whose operation is checked is shipped. In the shipped electronic device 100, the display on each of the display modules 3 is controlled based on corresponding adjustment information.

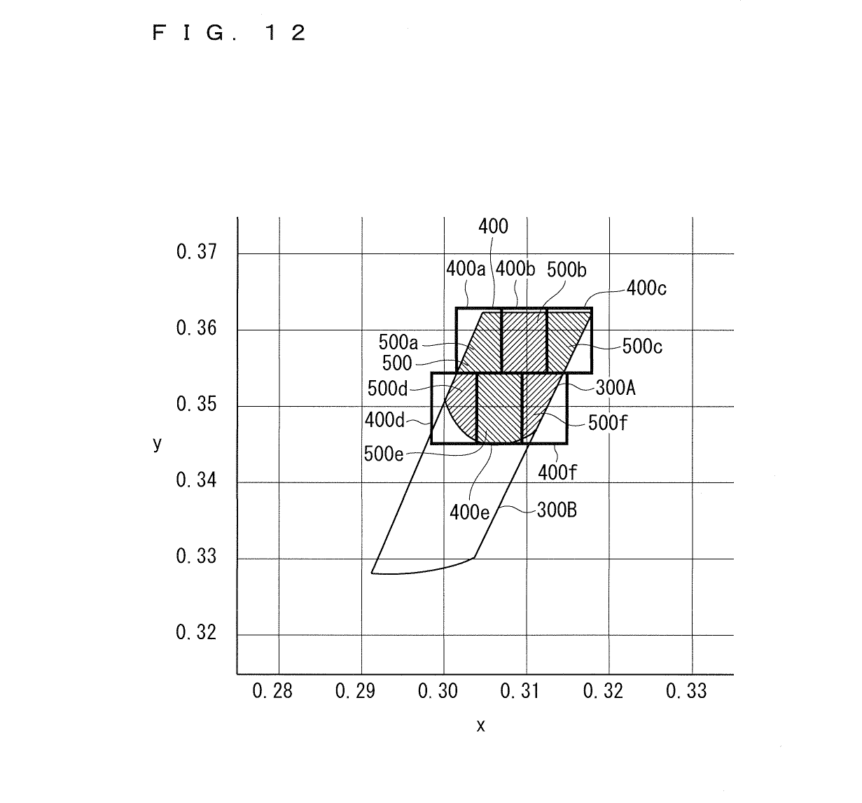

The process example in FIG. 11 is described below. When the process example in FIG. 11 is adopted, at a time point of the assembly of the electronic device 100, divided area range specifying information representing a range of each divided area, the plural pieces of adjustment information corresponding to respective the plurality of divided areas, and correspondence relationship information representing the correspondence relationship between the plural pieces of adjustment information and the plurality of divided areas are stored in the storage module 12 of the electronic device 100.

As shown in FIG. 11, at step s37, the measured values of the respective display modules 3 obtained at step s1 and s2 are stored in the storage module 12 of the electronic device 100 by the computer connected to the electronic device 100. The method for storing the measured values in the storage module 12 is not also limited to this, and for example, the measured values may be stored in the storage module 12 by a user's operation of the display screen 4. Further, when the electronic device 100 has the hardware key, the measured values may be stored in the storage module 12 by a user's operation of the hardware key.

Thereafter, when the electronic device 100 is powered on in order to check the operation, at step s38, the control module 10 reads the measured value of the first display module 3a from the storage module 12, and specifies a divided area to which the measured value belongs with reference to the divided area range specifying information in the storage module 12. Further, the control module 10 reads the measured value of the second display module 3b from the storage module 12, and specifies a divided area to which the measured value belongs with reference to the divided area range specifying information in the storage module 12.

At next step s39, the control module 10 specifies adjustment information about the first display module 3a corresponding to the specified divided area with reference to the correspondence relationship information in the storage module 12, and reads the adjustment information from the storage module 12 so as to input it into the first display module 3a. Further, the control module 10 specifies adjustment information about the second display module 3b corresponding to the specified divided area with reference to the correspondence relationship information in the storage module 12, and reads the adjustment information from the storage module 12 so as to input it into the second display module 3b.

Next, step s36 described above is executed, and, in each of the display modules 3, the display control module 33 controls the display on the liquid crystal display panel 30 based on the input adjustment information. As a result, white having chromaticity close to the target value is displayed on each of the display modules 3. Thereafter, the electronic device 100 whose operation is checked is shipped. In the shipped electronic device 100, the display on each of the display modules 3 is controlled based on corresponding adjustment information.

As described above, in this embodiment, the white chromaticity of each of the display modules 3 can be adjusted by the three methods.

Note that in the above example, the chromaticity adjustment method according to the embodiment is carried out at the process of manufacturing the electronic device 100, but may be suitably carried out in another situation. For example, when the electronic device 100 is repaired after shipment, the chromaticity adjustment method according to the embodiment may be carried out. Further, when the user of the electronic device 100 desires to adjust the white chromaticity of each of the display modules 3, the chromaticity adjustment method according to the embodiment may be carried out. In this case, the user measures the white chromaticity of the first display module 3a using the measuring instrument at step s1 described above, and the user measures the white chromaticity of the second display module 3b using the measuring instrument at step s2 described above. At step s3 described above, the user operates the computer connected to the electronic device 100 or the electronic device 100, so as to input adjustment information (example of FIG. 9), the first and second divided area specifying information (example of FIG. 10), or the measured values of the white chromaticity on the respective display modules 3 (example of FIG. 11) into the electronic device 100.

<Method for Dividing the White Chromaticity Variation Range>

FIG. 12 is a diagram illustrating a state that the white chromaticity variation range 300A shown in FIG. 7 is divided by a plurality of divided areas 500. In this embodiment, a plurality of unit regions 400 with rectangular shape are arranged so as to fill an entire region of the white chromaticity variation range. A portion on one unit region 400 which is included in the white chromaticity variation range is determined as one divided area 500, so that the white chromaticity variation range is divided into the plurality of divided areas 500.

In the example of FIG. 12, six unit regions 400 including a first unit region 400a to a sixth unit region 400f are arranged so as to fill the entire region of the white chromaticity variation range 300A without overlapping. As a result, the white chromaticity variation range 300A is divided into a first divided area 500a to a sixth divided area 500f corresponding to the first unit region 400a to the sixth unit region 400f respectively.

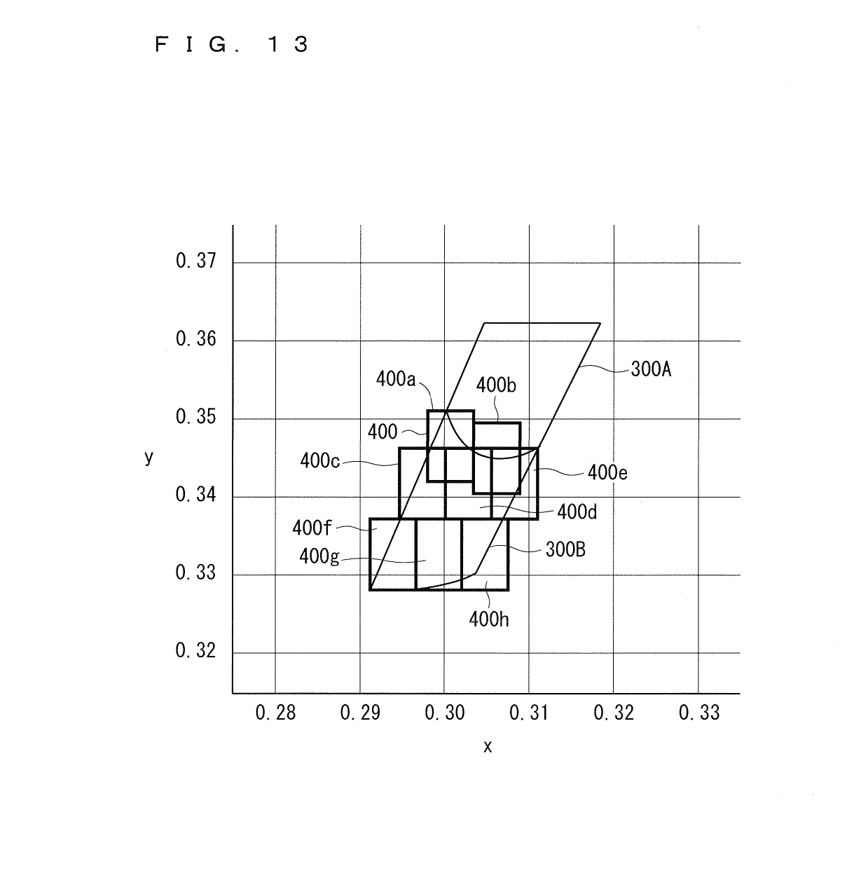

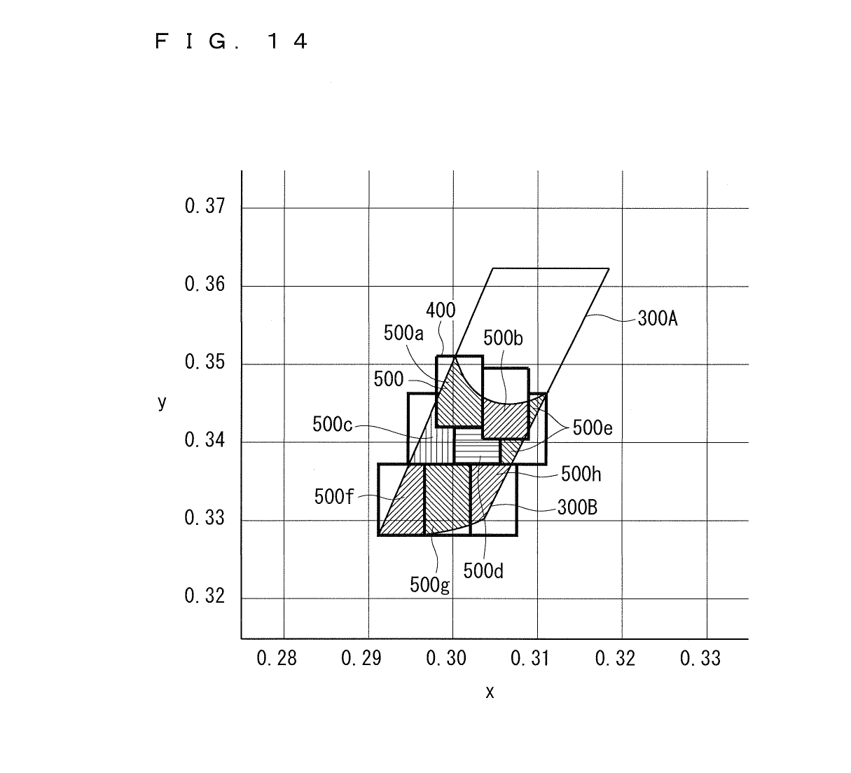

FIG. 13 is a diagram illustrating a state that the plurality of unit regions 400 is arranged so that the white chromaticity variation range 300B is divided into the plurality of divided areas 500. In an example of FIG. 13, when the white chromaticity variation range 300B is divided into the plurality of divided areas 500, eight unit regions 400 including the first unit region 400a to an eighth unit region 400h are arranged so as to be partially overlapped with each other. Concretely, the first unit region 400a overlaps with the third unit region 400c and the fourth unit region 400d, and the second unit region 400b overlaps with the fourth unit region 400d and the fifth unit region 400e. In such a manner, when the two unit regions 400 are overlapped with each other, the overlapped portion is regarded as belonging to any one of the two unit regions 400, and determines the divided area 500 of the two unit regions 400. FIG. 14 is a diagram illustrating a state that the white chromaticity variation range 300B is divided into the first divided area 500a to the eighth divided area 500h corresponding to the first unit region 400a to the eighth unit region 400h respectively.

<Method for Generating Adjustment Information>

A method for generating adjustment information is described below. The adjustment information according to the embodiment is composed of setting parameters for determining the operation of the display module 3. Concretely, the adjustment information is composed of setting parameters for determining a γ characteristic of an R component and a γ characteristic of a G component and a γ characteristic of a B component in the display module 3. When the setting parameter of the display module 3 is adjusted, γ value and highest luminance in the γ characteristic of the color component corresponding to the setting parameter can be adjusted. Since the white chromaticity of the display module 3 is determined by the highest luminance of the R component, the G component and the B component, the setting parameters of the R component, the G component and the B component are adjusted so that the white chromaticity of the display module 3 can be adjusted. Hereinafter, the setting parameters are called “γ characteristic setting parameters”.

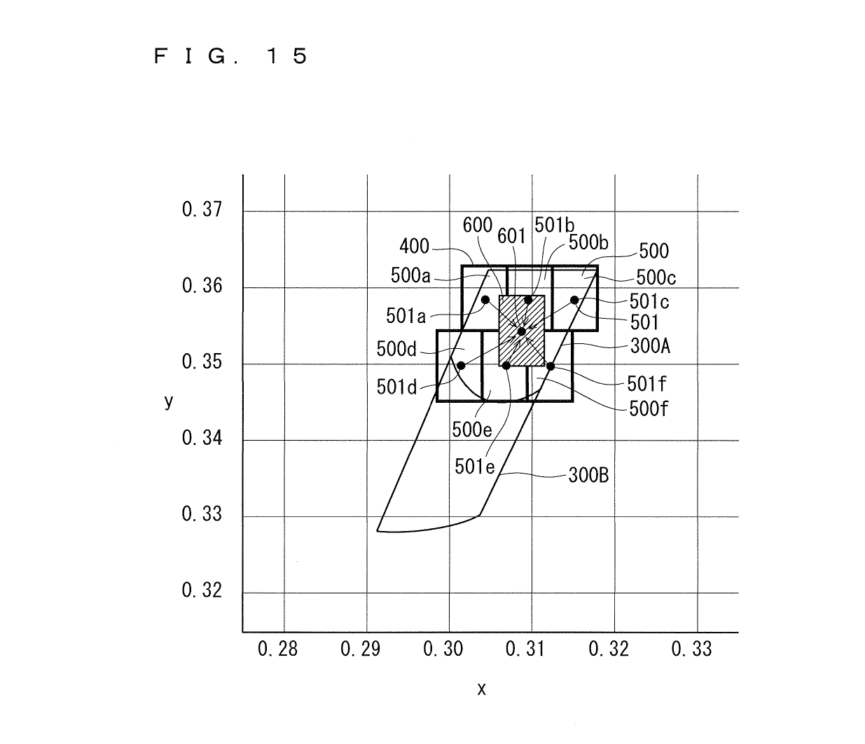

FIG. 15 is a diagram for describing the method for generating the adjustment information (the γ characteristic setting parameters of the R component, the G component and the B component) used by the electronic device 100 using the white LED 32a of the rank A.

As shown in FIG. 15, representative values 501a to 501f are set for first divided area 500a to the sixth divided area 500f, respectively. Hereinafter, when the representative values 501a to 501f do not have to be discriminated from each other, each of them is called “the representative value 501”. The representative value 501 of each of the divided areas 500 is determined within the unit region 400 corresponding to the divided area 500. Further, a variation acceptable range 600 is set within the white chromaticity variation range 300A. A center value of the variation acceptable range 600 is the target value 601.

The variation acceptable range 600 means a range that a difference in the chromaticity of white displayed by the first display module 3a and the second display module 3b is not noticeable when the variation in the white chromaticity among individual in each of the display modules 3 falls within this range, and the variation acceptable range 600 is determined by an experiment result or the like. Note that, in this embodiment, the width in an x direction of the unit region 400 and a width in a y direction of the unit region 400 are made to match with a width in the x direction of the variation acceptable range 600 and a width in the y direction of the variation acceptable range 600 respectively.

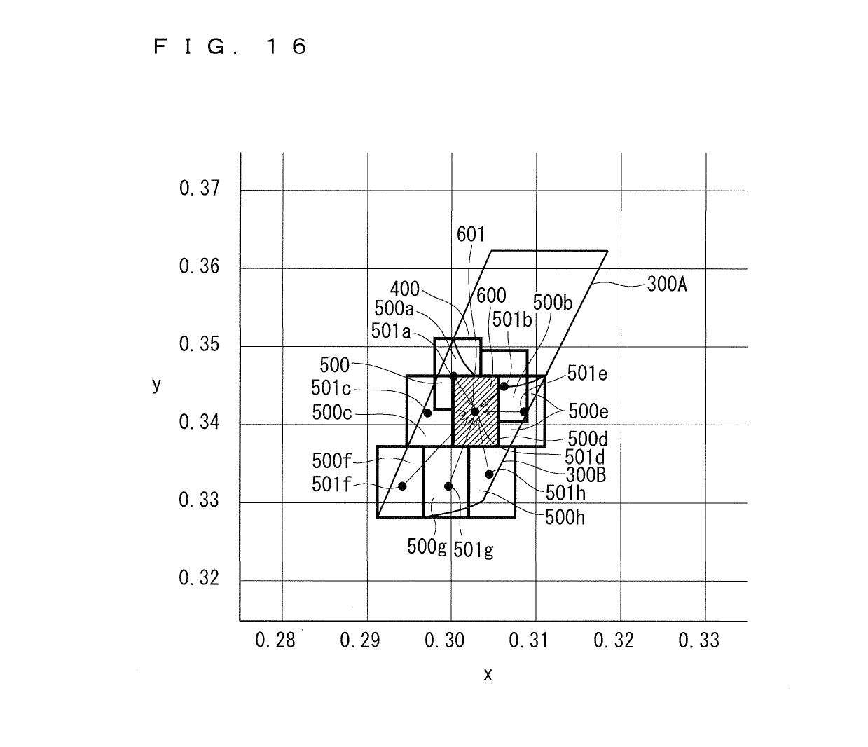

FIG. 16 is a diagram illustrating the representative values 501 set in the plurality of divided areas 500, respectively, in the white chromaticity variation range 300B, and the variation acceptable range 600 and a target value 601 set in the white chromaticity variation range 300B. In an example of FIG. 16, the representative values 501a to 501h are set in the first divided area 500a to the eighth divided area 500h, respectively. Further, in the example of FIG. 16, a large portion of the unit region 400 corresponding to the fourth divided area 500d overlaps with a large portion of the variation acceptable range 600, and the representative value 501d set on the fourth divided area 500d matches with the target value 601.

The adjustment information corresponding to a certain divided area 500 is generated based on the representative values 501 and the target value 601 about the divide area 500. The method for generating adjustment information based on the representative values 501 and the target value 601 is described below. Hereinafter, the divided area 500 to be described is occasionally called “the target divided area 500”.

When adjustment information corresponding to the target divided area 500 is obtained, firstly, adjustment amount of the highest luminance of each of the R component, the G component and the B component necessary for changing the white chromaticity of the display module 3 into the target value 601 is obtained in the case where the white chromaticity is the representative value 501 of the target divided area 500. Then, the γ characteristic setting parameter of the R component is obtained such that the display module 3 exhibits the γ characteristic such that the highest luminance of the R component indicates a value after adjusting by the corresponding adjustment amount. At this time, the γ characteristic setting parameter is determined so that the γ value of the γ characteristic of the R component does not change. Similarly, the γ characteristic setting parameter of the G component is obtained such that the display module 3 exhibits the γ characteristic such that the highest luminance of the G component indicates a value after adjusting by the corresponding adjustment amount, and the γ characteristic setting parameter of the B component is obtained such that the display module 3 exhibits the γ characteristic such that the highest luminance of the B component indicates a value after adjusting by the corresponding adjustment amount. At this time, the γ characteristic setting parameters are determined so that the γ values of the γ characteristics of the G component and the B component do not change. The γ characteristic setting parameters of the R component, the G component and the B component obtained in such a manner are the adjustment information corresponding to the target divided areas 500. The method for generating adjustment information is described in more detailed below.

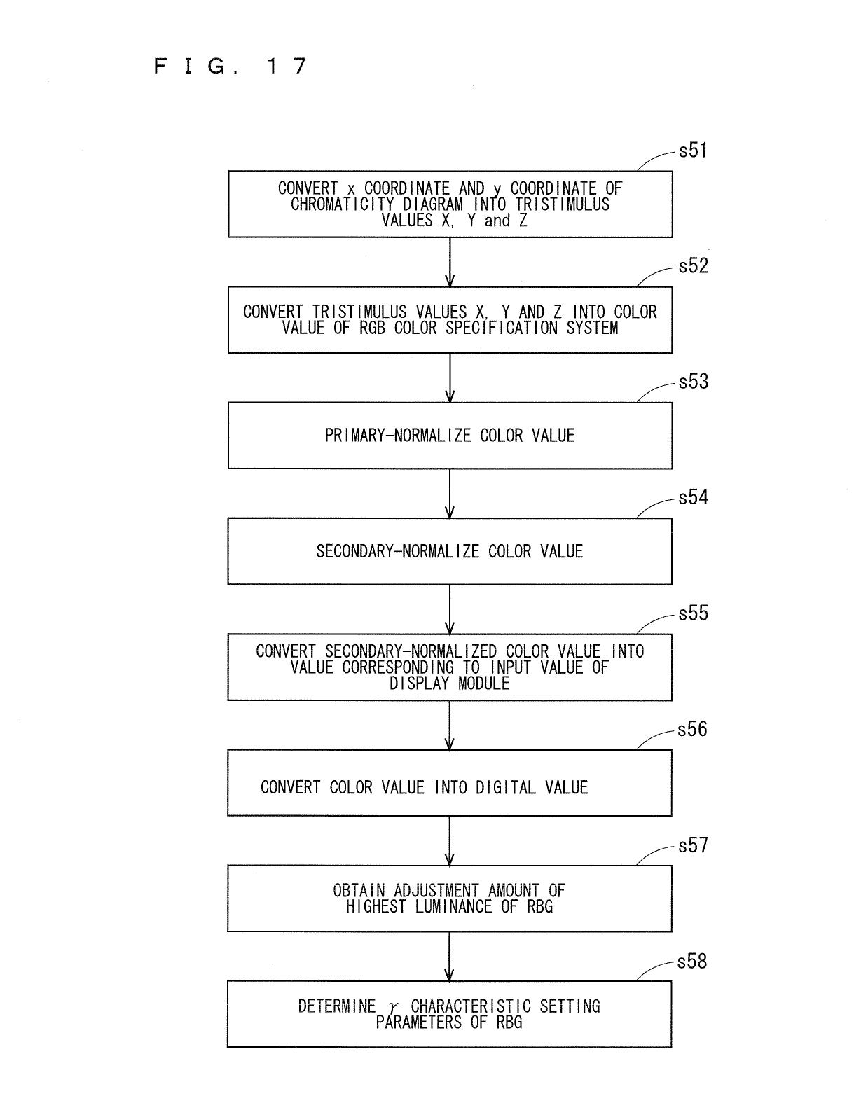

FIG. 17 is a flowchart illustrating a method for generating the adjustment information corresponding to the target divided area 500 based on the representative value 501 and the target value 601 about the target divided area 500.

As shown in FIG. 17, at step s51, an x coordinate and a y coordinate of each of the representative value 501 and the target value 601 in a chromaticity diagram are converted into tristimulus values X, Y and Z. A relationship among the x coordinate, y coordinate and the tristimulus values X, Y and Z is expressed by the following equations (1) to (3).

X=(x/y)×L (1)

Y=L (2)

Z=((1−x−y)/y)×L (3)

At next step s52, the tristimulus values X, Y and Z of the representative value 501 are converted into an R value, a G value and a B value of an RGB color specification system, and the tristimulus values X, Y and Z of the target value 601 are converted into the R value, G value and B value of the RGB color specification system. When the R value, G value and B value of the RGB color specification system are denoted by R1, G2 and B2, a relationship between the tristimulus values X, Y and Z, and values R1, G1 and B1 is expressed by the following equations (4) to (6).

R1=rx×X+gx×Y+bx×Z (4)

G1=ry×X+gy×Y+by×Z (5)

B1=rz×X+gz×Y+bz×Z (6)

Coefficients rx, ry, rz, gx, gy, gz, bx, by, and bz are determined based on measured values Rm of the chromaticities of red colors displayed by a plurality of samples of the display module 3, measured values Gm of the chromaticities of green color displayed by the samples, and measured values Bm of the chromaticities of blue color displayed by the samples.

An x coordinate and a y coordinate of the measured value Rm in a chromaticity diagram are denoted by Rmx and Rmy, and an x coordinate and a y coordinate of the measured value Gm in the chromaticity diagram are denoted by Gmx and Gmy, and an x coordinate and a y coordinate of the measured value Bm in the chromaticity diagram are denoted by Bmx and Bmy. Rmz=1−Rmx−Rmy, Gmz=1−Gmx−Gmy, and Bmz=1−Bmx−Bmy. In this embodiment, rx represents an average value of Rmx of the plural samples, gx represents an average value of Gmx of the plural samples, and bx represents an average value of Bmx of the plural samples. Further, ry represents an average value of Rmy of the plural samples, gy represents an average value of Gmy of the plural samples, and by represents an average value of Bmy of the plural samples. Further, rz represents an average value of Rmz of the plural samples, gz represents an average value of Gmz of the plural samples, and bz represents an average value of Bmz of the plural samples.

At next step s53, each of R values R1 of the representative value 501 and the target value 601 is normalized by the R value R1 of the representative value 501. That is, each of values that are obtained by dividing the R values R1 of the representative value 501 and the target value 601 by the R value R1 of the representative value 501, is a primary normalized R value R2.

Similarly, each of values, that are obtained by dividing G values G1 of the representative value 501 and the target value 601 by the G value G1 of the representative value 501, is a primary normalized G values G2. Further, each of values, that are obtained by dividing B values B1 of the representative value 501 and the target value 601 by the B value B1 of the representative value 501, is a primary normalized B values B2. All the primary normalized R value R2, the primary normalized G value G2, and the primary normalized B value B2 of the representative value 501 are “1”.

At next step s54, the primary normalized R value R2, the primary normalized G value G2, and the primary normalized B value B2 of the representative value 501 are normalized by the maximum value of them. That is, values, that are obtained by dividing the primary normalized R value R2, the primary normalized G value G2, and the primary normalized B value B2 of the representative value 501 by the maximum value of these values, are a secondary normalized R value R3, a secondary normalized G value G3, and a 2 normalized B value B3.

Similarly, values, that are obtained by dividing the primary normalized R value R2, the primary normalized G value G2, and the primary normalized B value B2 of the target value 601 by the maximum value of these values, are the secondary normalized R value R3, the secondary normalized G value G3, and the 2 normalized B value B3. All the secondary normalized R value R3, the secondary normalized G value G3, and the secondary normalized B value B3 of the representative value 501 are “1”.

Since the secondary normalized R value R3, the secondary normalized G value G3, and the secondary normalized B value B3 correspond to output luminance of the display module 3, at next step s55, these values are converted into values corresponding to input values of the display module 3 based on γ value of γ characteristic of the display module 3. Concretely, when the γ value of the γ characteristic is represented by “γ”, R3^{(1/γ)}, G3^{(1/γ)}, and B3^{(1/γ)} of each of the representative value 501 and the target value 601 are obtained. Hereinafter, R3^{(1/γ)}, G3^{(1/γ)}, and B3^{(1/γ)} are an input R value R4, an input G value G4, and an input B value B4, respectively. All the input R value R4, the input G value G4, and an input B value B4 of the representative value 501 are “1”.

At next step s56, the input R value R4, the input G value G4, and the input B value B4 of each of the representative value 501 and the target value 601 are converted into digital values. In this embodiment, the R value, the G value, and the B value of a pixel signal of a digital format generated by the control module 10 are expressed by, for example, 8 bits. At step s55, values, that are obtained by multiplying the input R value R4, the input G value G4, and the input B value B4 of each of the representative value 501 and the target value 601 by “255”, are a digital R value R5, a digital G value G5, and a digital B value B5, respectively. All the digital R value R5, the digital G value G5, and the digital B value B5 of the representative value 501 are “255”.

At next step s57, the adjustment amount αR of the highest luminance of the R component composing a pixel displayed on the display module 3 is obtained based on the digital R values R5 of the representative value 501 and the target value 601. Concretely, the digital R value R5 of the representative value 501 is denoted by “R5p” and the digital R value R5 of the target value 601 is denoted by “R5t”, the adjustment amount αR (unit is %) is obtained by the following equation (7).

αR=100×((R5t/R5p)−1) (7)

Since the digital R value R5 of the representative value 501 is “255”, the equation (7) is eventually the following equation (8).

αR=100×((R5t/255)−1) (8)

Similarly, at step s56, the adjustment amount αG of the highest luminance of the G component composing a pixel displayed by the display module 3 is obtained based on the digital values G5 of the representative value 501 and the target value 601, and the adjustment amount αB of the highest luminance of the B component composing a pixel displayed by the display module 3 is obtained based on the digital B values B5 of the representative value 501 and the target value 601.

At next step s58, the γ characteristic setting parameter of the R component is obtained such that the display module 3 exhibits the γ characteristic such that the highest luminance of the R component indicates a value after adjusting by the adjustment amount αR. Further, the γ characteristic setting parameter of the G component is obtained such that the display module 3 exhibits the γ characteristic such that the highest luminance of the G component indicates a value after adjusting by the adjustment amount αG. Further, the γ characteristic setting parameter of the B component is obtained such that the display module 3 exhibits the γ characteristic such that the highest luminance of the B component indicates a value after adjusting by the adjustment amount αB.

When an attention is paid to a certain color component of the R component, the G component, and the B component, the certain color component is called a target color component, a digital value of the target color component composing a pixel signal input into the display module 3 is denoted by Vin, and luminance of the target color component on the display module 3 (unit is cd/m²) is denoted by Vout, a relationship between Vin and Vout can be expressed by the following equation (9).

Vout=β×Vin^{γ} (9)

However, a coefficient β is for converting the digital value of the target color component, which is input into the display module 3, into a unit of luminance.

As is clear from the equation (9), a γ characteristic of the target color component is determined by the coefficient β and the γ value, and the γ characteristic setting parameter of the target color component is the coefficient β and the γ value. In this embodiment, as to the coefficient β and γ value composing the γ characteristic setting parameters of the target color component, the γ value is kept unchanged and the coefficient β is adjusted, whereby the γ characteristic setting parameter of the target color component is obtained such that the display module 3 exhibits a γ characteristic such that the highest luminance of the target color component indicates a value after adjusting by the adjustment amount obtained at step s57. As a result, the γ characteristic setting parameter is determined so that the γ value in the γ characteristic of the target color component does not change.

For example, a value before the coefficient β of the R component in the γ characteristic setting parameter is adjusted is β1, and a value after the coefficient β is adjusted is β2, β2 is expressed by the following equation (10) using the adjustment amount αR.

β2=β1×(100+αR)/100 (10)

In this embodiment, β2 and γ value expressed by the equation (10) become the γ characteristic setting parameters of the R component such that the display module 3 exhibits the γ characteristic such that the highest luminance of the R component indicates a value after adjusting by the adjustment amount αR. The γ characteristic setting parameter of each of the G component and the B component is obtained similarly.

The γ characteristic setting parameters of the R component, the G component, and the B component obtained in such a manner are adjustment information corresponding to the target divided area 500.

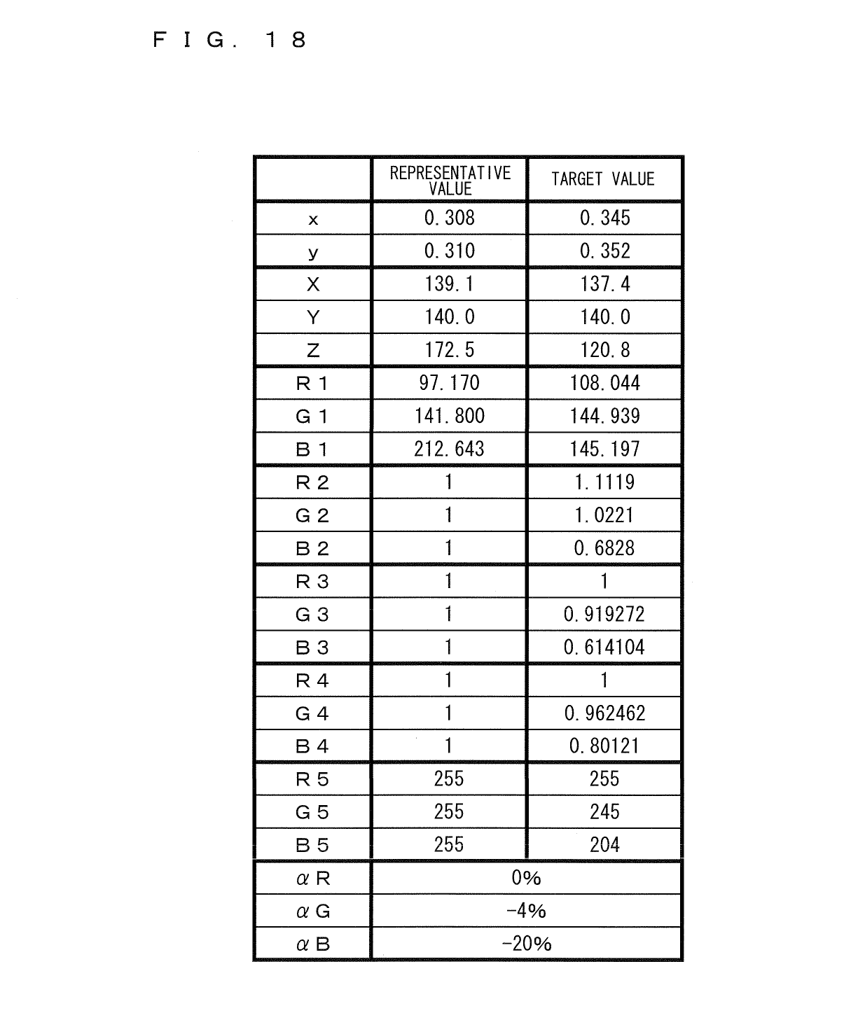

FIG. 18 is a diagram illustrating examples of the numerical values with respect to respective values to be obtained at steps s51 to s57. In the example of FIG. 18, the x coordinate and the y coordinate of the representative value 501 on the target divided area 500 is “0.308” and “0.310”, respectively, and the x coordinate and the y coordinate of the target value 601 are “0.345” and “0.352”. Further, as to the coefficients rx, ry, rz, gx, gy, gz, bx, by, and bz, rx=0.645, ry=0.323, rz=0.0032, gx=0.323, gy=0.643, gz=0.034, bx=0.144, by=0.082, and bz=0.774. Then, y=2.2.

As shown in FIG. 18, if the white chromaticity of the display module 3 is positioned on coordinates (0.308, 0.310) in the chromaticity diagram, the highest luminance of the R component on the display module 3 is not changed, the highest luminance of the G component is reduced by 4%, and the highest luminance of the B component is reduced by 20%, the white chromaticity of the display module 3 matches with a target value positioned on coordinates (0.345, 0.352) in the chromaticity diagram.

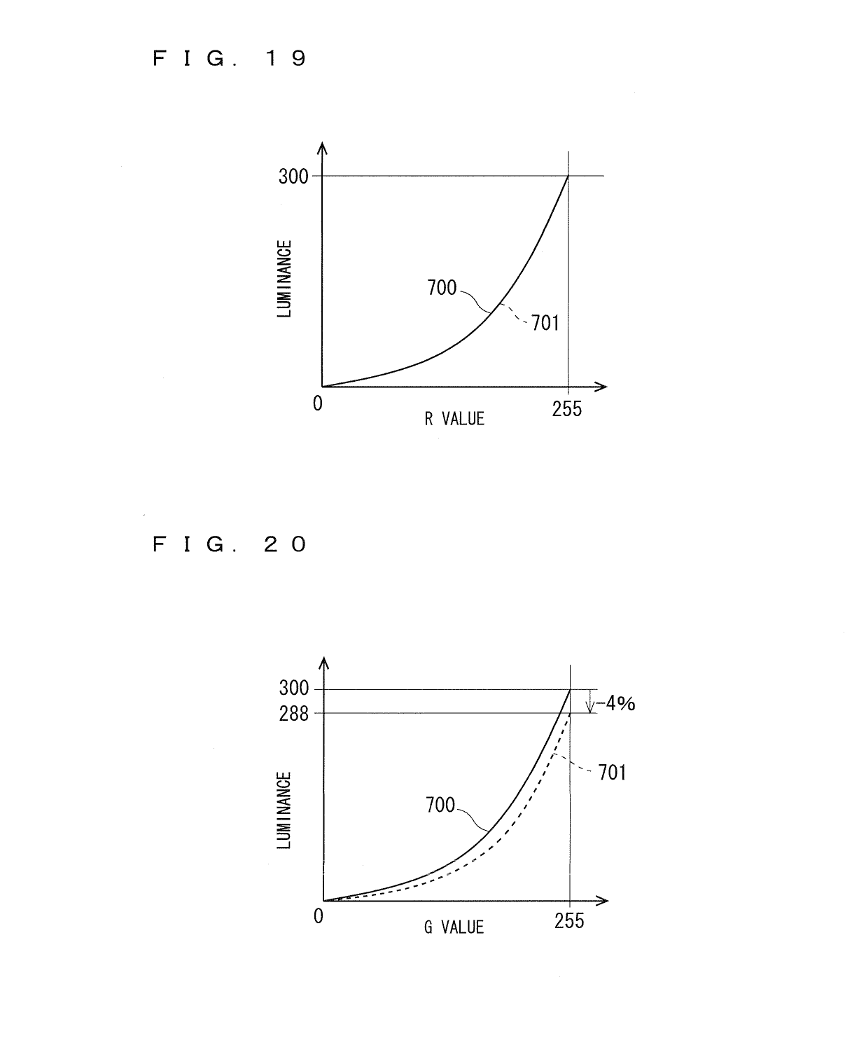

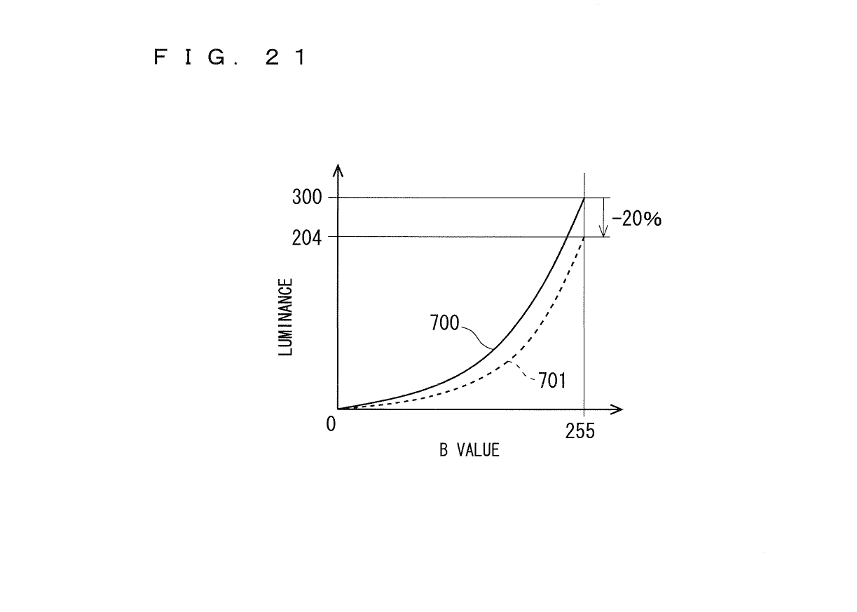

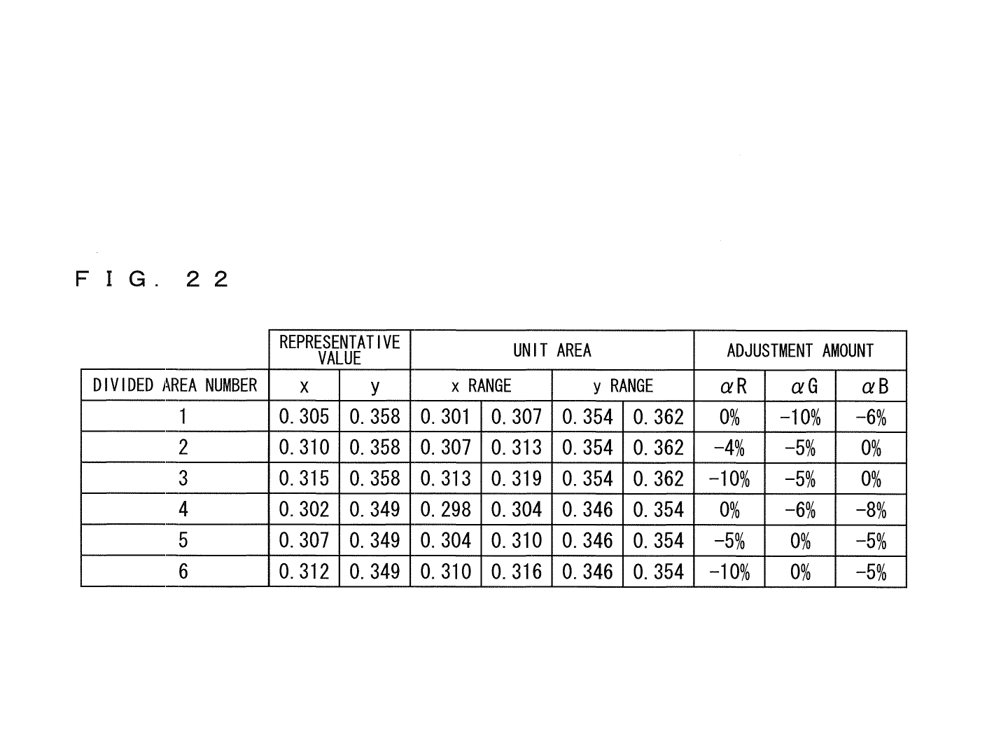

FIG. 19 is a diagram illustrating a state that the highest luminance of the R component is adjusted using the adjustment amount αR shown in FIG. 18. FIG. 20 is a diagram illustrating a state that the highest luminance of the G component is adjusted by using the adjustment amount αG shown in FIG. 18. FIG. 21 is a diagram illustrating a state that the highest luminance of the B component is adjusted by using the adjustment amount αB shown in FIG. 18.

FIGS. 19 to 22 illustrate, γ characteristics 700 before the adjustment and γ characteristics 701 after the adjustment about the R component, the G component, and the B component are indicated by a solid line and a wavy line respectively. In FIGS. 19 to 22, an abscissa axis represents a color value input from the control module 10 into the display control module 33 (a value that 8-bit data is indicated as a decimal), and an ordinate axis represents luminance. Further, in the examples of FIGS. 19 to 21, the highest luminance before the adjustment is, for example, 300 cd/m². Since the adjustment amount αR of the R component is 0%, the γ characteristic 700 of the R component before the adjustment overlaps with the γ characteristic 701 after the adjustment.

As shown in FIG. 18, since the adjustment amount αG=−4%, as shown in FIG. 20, the highest luminance of the G component, namely, the luminance of the G component at a time when G value=255 is reduced from 300 cd/m² to 288 cd/m². Further, as shown in FIG. 18, since the adjustment amount αB=−20%, as shown in FIG. 21, the highest luminance of the B component, namely, the luminance of the B component at a time when B value=255 is reduced from 300 cd/m² to 204 cd/m². The y characteristic setting parameter of the G component is determined so that the y characteristic of the G component is the γ characteristic 701 (wavy line in FIG. 20) after the adjustment of the highest luminance, and the γ characteristic setting parameter of the B component is determined so that the γ characteristic of the B component is the γ characteristic 701 (wavy line in FIG. 21) after the adjustment of the highest luminance. At this time, the γ value of the γ characteristic after the highest luminance is adjusted is not changed from the γ value of the γ characteristic before the highest luminance is adjusted. As a result, the adjustment of the white chromaticity on the plurality of display modules 3 can suppress an increase in a difference in chromaticity of another color displayed by the plurality of display modules 3. In a case of the example of FIG. 18, as shown in FIG. 19, the γ characteristic of the R component does not change.

In the embodiment, for each of divided areas 500, the corresponding adjustment information (the γ characteristic setting parameters of the respective color components) is obtained based on the representative value 501 of the divided area 500 and the target value 601, as described above.

In the embodiment, as described above, when the measured value of the white chromaticity on the display module 3 belongs to a certain divided area 500, the white chromaticity on the display module 3 is adjusted based on adjustment information corresponding to this divided area 500 so that the white chromaticity approaches the target value 601. At this time, in the embodiment, the adjusted white chromaticity falls within the variation acceptable range 600. That is, even when the measured value of the white chromaticity on the display module 3 is present on any position of the certain divided area 500, the white chromaticity on the display module 3 is adjusted based on the adjustment information corresponding to this divided area 500, so that the adjusted white chromaticity falls within the variation acceptable range 600. In other words, even when the measured value of the white chromaticity on the display module 3 is present on any position of the certain divided area 500, the display control module 33 controls the liquid crystal display panel 30 based on the γ characteristic setting parameters corresponding to this divided area 500 so that the white chromaticity on the display module 3 falls within the variation acceptable range 600.

In the embodiment, the plurality of divided areas 500 is suitably determined on the white chromaticity variation range, and the representative value 501 is suitably determined on each of the plurality of divided areas 500, so that the adjusted white chromaticity falls within the variation acceptable range 600. In other words, the plurality of divided areas 500 and their representative values 501 are set in the white chromaticity variation range so that the adjusted white chromaticity falls within the variation acceptable range 600.

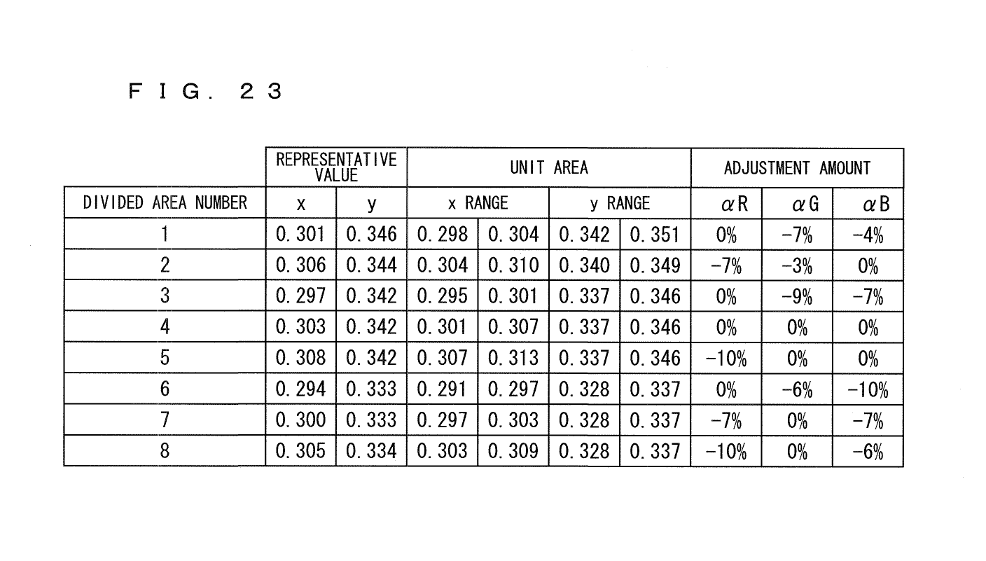

FIG. 22 is a diagram illustrating the adjustment amounts αR, αG and αB corresponding to each of the divided areas 500 in a case where the first divided area 500a to the sixth divided area 500f, the representative values 501a to 501f, and the target value 601 are set in the white chromaticity variation range 300A like the example in FIG. 15 described above. FIG. 22 illustrates the x coordinate and the y coordinate of each of the representative values 501, and an x direction range and a y direction range of the unit region 400 corresponding to each of the divided areas 500. The x coordinate and the y coordinate of the target value 601 shown in FIG. 15 are “0.309” and “0.354”, respectively, and an x direction width and a y direction width of the variation acceptable range 600 are “0.006” and “0.008”, respectively. In the example of FIG. 15, the α characteristic setting parameters of the R component, the G component and the B component on each of the divided areas 500 are determined based on the adjustment amounts αR, αG and αB shown in FIG. 22.

FIG. 23 is a diagram illustrating the adjustment amounts αR, αG and αB corresponding to each of the divided areas 500 in a case where the first divided area 500a to the eighth divided area 500h, the representative values 501a to 501h, and the target value 601 are set in the white chromaticity variation range 300B like the example in FIG. 16 described above. FIG. 23 illustrates an x coordinate and a y coordinate of each of the representative values 501, and an x direction range and a y direction range of the unit region 400 corresponding each of the divided areas 500 similarly to FIG. 22. The x coordinate and the y coordinate of the target value 601 shown in FIG. 16 are “0.303” and “0.342”, respectively, and an x direction width and a y direction width of the variation acceptable range 600 are “0.006” and “0.009”, respectively. In the example shown in FIG. 16, the γ characteristic setting parameters of the R component, the G component, and the B component on each of the divided areas 500 are determined based on the adjustment amounts αR, αG and αB shown in FIG. 23.

As described above, in the embodiment, since each of chromaticities of the same color as that of the backlight 32 displayed by the plurality of display modules 3 is adjusted so that the chromaticity approaches the target value 601, a difference in chromaticity of the same color as that of the backlight 32 displayed by the plurality of display modules 3 can be reduced. Therefore, discomfort, that is felt by the user when the user simultaneously views the plurality of display screens 4 displaying the same color as that of the backlight 32, can be reduced.

In the embodiment, since chromaticity of the same color as that of the backlight 32 displayed by the display module 3 is adjusted so that the γ value on the display module 3 does not change, this adjustment process can suppress an increase in a difference in chromaticity of another color displayed by the plurality of display modules 3.

### First Modified Example

In the above embodiment, even when the measured values of the white chromaticity on the plurality of display modules 3 belong to the same divided area 500, the white chromaticity on each of the display modules 3 is adjusted so as to approach a target value. When the measured values of the white chromaticity on the plurality of display modules 3 belong to the same divided area 500, a difference in chromaticity among them is small. For this reason, in this case, the white chromaticity on each of the display modules 3 does not have to be adjusted. As a result, the adjustment process on the white chromaticity on the display modules 3 is simplified.

### Second Modified Example

In the above embodiment, at step s3 in FIG. 8, the white chromaticity on the display modules 3 is adjusted based on prepared adjustment information, but at step s3, adjustment information for making the white chromaticity on the display modules 3 approach the target value 601 may be generated based on the measured values of the white chromaticity on the display module 3 obtained at steps s1 and s2. The process at step s3 in this modified example is described below.

At step s3 according to this modified example, adjustment information for adjusting the white chromaticity on the first display module 3a is generated based on the measured value of the white chromaticity on the first display module 3a obtained at step s1 and the target value 601. Concretely, at step s3, a series of the process for generating adjustment information shown in FIG. 17 described above is executed using the measured value of the white chromaticity on the first display module 3a instead of the representative values 501. As a result, at step s3, adjustment information for changing the white chromaticity on the first display module 3a into the target value 601, namely, the γ characteristic setting parameters of the R component, the G component, and the B component such that the white chromaticity on the first display module 3a becomes the target value 601 is generated.

Similarly, at step s3, a series of the process for generating adjustment information shown in FIG. 17 described above is executed using the measured value of the white chromaticity on the second display module 3b obtained at step s2 instead of the representative values 501. As a result, at step s3, adjustment information for changing the white chromaticity on the second display module 3b into the target value 601, namely, the γ characteristic setting parameters of the R component, the G component, and the B component such that the white chromaticity on the second display module 3b becomes the target value 601 are generated.

The process for generating adjustment information may be performed by the computer connected to the electronic device 100 or in the electronic device 100. In the former case, the adjustment information about each of the display modules 3 generated by a computer is stored in the storage module 12 of the electronic device 100 by the computer. In the electronic device 100, display on each of the display modules 3 is controlled based on the adjustment information corresponding to the display module 3. On the other hand, in the latter case, the measured values of the white chromaticity on each of the display modules 3 obtained at steps s1 and s2 are stored in the storage module 12 of the electronic device 100. The control module 10, that functions as an adjusting module for adjusting the chromaticity of each of the display modules 3, generates adjustment information about each of the display modules 3 based on the measured values stored in the storage module 12. Thereafter, in the electronic device 100, the display on each of the display modules 3 is controlled based on adjustment information corresponding to the display module 3.

When adjustment information is generated based on the measured values of the white chromaticity on each of the display modules 3, the white chromaticity of each of the display modules 3 can be allowed to approach the target value 601 more accurately. Therefore, a difference in chromaticity of the same color as that of the backlight 32 displayed by the plurality of display modules 3 can be further reduced.

On the other hand, like the above embodiment, the white chromaticity variation range is divided into the plurality of divided areas 500, and adjustment information is prepared for the divided areas 500, so that the adjustment information about the display module 3 does not have to be generated every time when the white chromaticity is adjusted. For this reason, the adjustment process is simplified.

Note that, in the electronic device 100, when adjustment information about each of the display modules 3 is generated, instead of input of an actual measured value of the white chromaticity on the display module 3 into the electronic device 100, a plurality of values that is likely to be obtained as the white chromaticity of the display module 3 is stored as candidate values in the storage module 12 of the electronic device 100 in advance, and the user operates the display screen 4 of the display module 3 so that a candidate value that seems to be a value of the white chromaticity of the display module 3 can be selected from the plurality of candidate values. In this case, the candidate value of white chromaticity on the display module 3 selected by the user is used instead of the actual measured value of the display module 3, so that adjustment information about the display module 3 is generated.

Further, also in the example shown in FIG. 11 described above, instead of input of an actual measured value of the white chromaticity on the display module 3 into the electronic device 100, a plurality of values that is likely to be obtained as the white chromaticity of the display module 3 is stored as candidate values in the storage module 12 of the electronic device 100 in advance, and the user operates the display screen 4 of the display module 3 so that a candidate value that seems to be a value of the white chromaticity of the display module 3 can be selected from the plurality of candidate values at step s37. In this case, the candidate value of the white chromaticity on the display module 3 selected by the user is used at step s38 instead of the actual measured value of the display module 3, and a divided area to which the candidate value belongs is specified. Thereafter, at step s36, display on the display module 3 is controlled based on the adjustment information related to the divided area specified at step s38.

Even when the user selects a value that is replacement for an actual measured value of the white chromaticity on each of the display modules 3, a difference in white chromaticity of the plurality of display modules 3 can be reduced.

### Another Modified Example

The electronic device 100 according to the above embodiment is the mobile phone having the two display modules 3, but may be an electronic device that has three or more display modules 3, and is used in a form such that the display screens 4 of the three or more display modules 3 are simultaneously viewable. Even in the electronic device 100 having the three or more display modules 3, each of chromaticities of the same color as that of the backlight 32 displayed by the three or more display modules 3 are adjusted so as to approach the target value as described above, so that a difference in the chromaticity of the same color as that of the backlight 32 displayed by the three or more display module 3 can be reduced.

Further, in the above embodiment, the color of light emitted from the backlight 32 is white, but light of another color may be emitted.

Further, the above embodiment described the example of the case where the present invention is applied to the mobile phone, but the present invention can be applied also to electronic devices other than mobile phones. For example, the present invention can be applied to game machines, notebook computers, e-books, navigation systems, and music players.

While the invention has been shown and described in detail, the foregoing description is in all aspects illustrative and not restrictive. It is therefore understood that numerous modifications and variations can be devised without departing from the scope of the invention.

### EXPLANATION OF LETTERS OR NUMERALS

3 display module
3a first display module
3b second display module
4a first display screen
4b second display screen
10 control module
12 storage module
32 backlight
100 electronic device

1. An electronic device, comprising:
a plurality of display modules; and
an adjusting module operable to adjust chromaticity of the plurality of display modules,
wherein each of the plurality of display modules comprises a display screen and a backlight operable to emit light of a predetermined color and to illuminate the display screen from the rear surface side,
the display screens of the plurality of display modules are simultaneously viewable, and
the adjusting module performs, for each of the plurality of display modules, an adjustment process for adjusting target chromaticity so that the target chromaticity to be displayed on the display module approaches a target value, the target chromaticity being chromaticity of the same color as the predetermined color.

2. The electronic device according to claim 1, wherein
the adjusting module performs, for each of the plurality of display modules, the adjustment process so that a γ value on the display module does not change.

3. The electronic device according to claim 1, wherein
a range where the target chromaticity varies among individuals is divided into a plurality of divided areas, the device further comprising:
a storage module operable to store multiple pieces of adjustment information for making the target chromaticity approach the target value, the multiple pieces of adjustment information being corresponding to respective the plurality of divided areas therein,
the adjusting module performing, for each of the plurality of display modules, the adjustment process based on the adjustment information corresponding to the divided area to which a value of the target chromaticity of the display module belongs.

4. The electronic device according to claim 3, wherein
each of the multiple pieces of adjustment information is obtained based on a representative value of the divided area corresponding to the adjustment information and the target value.

5. The electronic device according to claim 3, wherein
when the divided areas, to which values of the target chromaticities on the plurality of display modules belong, match with each other, the adjusting module does not perform the adjustment process for each of the plurality of display modules.

6. The electronic device according to claim 1, wherein
the adjusting module generates, for each of the plurality of display modules, adjustment information for making the target chromaticity of the display module approach the target value based on the value of the target chromaticity on the display module and the target value, and performs, for each of the plurality of display modules, the adjustment process based on the adjustment information about the display module.

7. A chromaticity adjustment method for an electronic device including a plurality of display modules each of which comprises a display screen and a backlight emitting light of a predetermined color for illuminating the display screen from the rear surface side, the display screens of the plurality of display modules being simultaneously viewable, the method comprising the steps of:
(a) measuring, for each of the plurality of display modules, target chromaticity to be displayed by the display module, the target chromaticity being chromaticity of the same color as the predetermined color; and
(b) performing, for each of the plurality of display modules, an adjustment process for adjusting the target chromaticity based on a measured value of the display module obtained in the step (a) so that the target chromaticity of the display module approaches a target value.

8. The chromaticity adjustment method according to claim 7, wherein
in the step (b), the adjustment process is performed for each of the plurality of display modules so that a γ value of the display module does not change.

9. The chromaticity adjustment method according to claim 7, wherein
a range where the target chromaticity varies among individuals is divided into a plurality of divided areas, and multiple pieces of adjustment information, which is corresponding to respective the plurality of divided areas, for making the target chromaticity approach the target value is prepared,
in the step (b),
the adjustment process is performed for each of the plurality of display modules based on adjustment information corresponding to the divided area to which the measured value on the display module belongs.

10. The chromaticity adjustment method according to claim 9, wherein
in the step (b),
for each of the plurality of display modules, the adjustment information corresponding to the divided area to which the measured value on the display module belongs is stored in the electronic device, and in electronic device, display on each of the plurality of display modules is controlled based on adjustment information about the display module.

11. The chromaticity adjustment method according to claim 9, wherein,
the electronic device stores the multiple pieces of adjustment information,
in the step (b),
for each of the plurality of display modules, divided area specifying information representing the divided area to which the measured value on the display module belongs is stored in the electronic device, and in the electronic device, display of each of the plurality of display modules is controlled based on the adjustment information corresponding to the divided area represented by the divided area specifying information about the display module.

12. The chromaticity adjustment method according to claim 9, wherein
the electronic device stores the multiple pieces of adjustment information,
in the step (b),
the measured value of each of the plurality of display modules is stored in the electronic device, and in electronic device, display on each of the plurality of display modules is controlled based on the adjustment information corresponding to the divided area to which the measured value on the display module belongs.

13. The chromaticity adjustment method according to claim 9, wherein
each of the multiple pieces of adjustment information is obtained based on representative value of the divided area corresponding to the adjustment information and the target value.

14. The chromaticity adjustment method according to claim 9, wherein
when the divided areas to which the measured values on the plurality of display modules belong match with each other, in the step (b), the adjustment process is not performed for each of the plurality of display modules.

15. The chromaticity adjustment method according to claim 7, wherein
in the step (b),
for each of the plurality of display modules, adjustment information for making the target chromaticity on the display module approach the target value is generated based on the measured value of the display module and the target value, and the adjustment process is performed for each of the plurality of display modules based on the adjustment information about the display module.

16. The chromaticity adjustment method according to claim 15, wherein
in the step (b),
the adjustment information about each of the plurality of display modules is stored in the electronic device, and in the electronic device, display on each of the plurality of display modules is controlled based on the adjustment information about the display module.

17. The chromaticity adjustment method according to claim 15, wherein
in the step (b),
the measured value of each of the plurality of display modules is stored in the electronic device, and in electronic device, for each of the plurality of display modules, the adjustment information is generated based on the measured value of the display module and the target value, and in the electronic device, display of each of the plurality of display modules is controlled based on the adjustment information about the display module.
